(19) United States
(12) Patent Application Publication
(10) Pub. No.: US 2010/0225905 A1
(43) Pub. Date: Sep. 9, 2010

(54) INSPECTION METHOD AND INSPECTION APPARATUS FOR SEMICONDUCTOR SUBSTRATE

(75) Inventor: Hiroyuki HAYASHI, Mie (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/560,017

(22) Filed: Sep. 15, 2009

(30) Foreign Application Priority Data
Mar. 4, 2009 (JP) 2009-051046

(51) Int. Cl. G01N 21/00

(52) U.S. Cl. 356/237.5

(57) ABSTRACT

An inspection method for a semiconductor substrate includes irradiating an inspection beam on wires formed on a semiconductor substrate, detecting a secondary beam emitted from the semiconductor substrate, generating a contrast image, which indicates a state of an inspection surface of the semiconductor substrate, according to a gray level corresponding to signal intensity of the secondary beam, specifying a wire as an inspection target and a wire as a non-inspection target and acquiring a position and a dimension of the wire as the non-inspection target and a gray level corresponding to a wire non-forming area, replacing an image of the wire as the non-inspection target in the contrast image with an image having the gray level corresponding to the wire non-forming area, and inspecting, based on the contrast image after the replacement processing, a defect of the wire as the inspection target.

### CROSS-REFERENCE TO RELATED APPLICATIONS

This application is based upon and claims the benefit of priority from the prior Japanese Patent Application No. 2009-051046, filed on Mar. 4, 2009; the entire contents of which are incorporated herein by reference.

### BACKGROUND OF THE INVENTION

1. Field of the Invention

The present invention relates to an inspection method and an inspection apparatus for a semiconductor substrate, and, more particularly to an inspection method and an inspection apparatus of electric short-circuit and open-circuit in a semiconductor substrate.

2. Description of the Related Art

In a defect inspection in a hole forming process in manufacturing of a semiconductor device, a defect inspection method for acquiring a potential contrast image on a wire surface present in specific one chip on a wafer surface and comparing potential contrast images on the same wire surface between cells or dies adjacent to each other to detect a defect of wires is used (e.g., Japan Society for the Promotion of Science, the 132nd Committee, 24th LSI Testing Symposium/2004 “Line Monitoring Method by Potential Contrast Defect Detection p 77-83”, Microlithography. Proceedings of SPIE vol. 5752 (2004) pp. 997-1008/Development of voltage contrast inspection technique for line monitoring 300 mm ULSI hp90 logic contact layer).

In general, such a defect inspection system is referred to as cell-to-cell image comparison inspection system or die-to-die image comparison inspection system depending on whether image comparison is performed between cells or between dies. For example, a defect inspection apparatus for inspecting a defect using an electron beam represented by a product of KLA-Tencor Corporation adopts this system (concerning an inspection apparatus for inspecting a defect in a semiconductor device using an electron beam, see, for example, U.S. Pat. No. 6,768,324). The cell-to-cell image comparison inspection system is used when dies in which repetition wiring is present as in a memory device are inspected. The die-to-die image comparison inspection system is used when dies in which repetition wires are not present as in a logic device are inspected.

In an inspection method for irradiating an electron beam on the surface of a semiconductor substrate, creating potential contrast images on the wire surface, and detecting critical defects (open circuit and short circuit) present in a layer under wires from a difference image of the potential contrast images, when there are various wires in a device, fluctuation occurs in contrast in each of the wires. As a result, it is likely that deterioration in inspection accuracy is caused.

### BRIEF SUMMARY OF THE INVENTION

According to an aspect of the present invention, an inspection method for a semiconductor substrate includes irradiating an inspection beam on wires formed on a semiconductor substrate while scanning the inspection beam, detecting a secondary beam emitted from the semiconductor substrate according to the irradiation of the inspection beam, generating a contrast image, which indicates a state of an inspection surface of the semiconductor substrate, according to a gray level corresponding to signal intensity of the secondary beam, specifying, based on a change in the gray level in the contrast image, a wire as an inspection target and a wire as a non-inspection target and acquiring a position and a dimension of the wire as the non-inspection target and a gray level corresponding to a wire non-forming area, replacing, based on the position and the dimension of the wire as the non-inspection target, an image of the wire as the non-inspection target in the contrast image with an image having the gray level corresponding to the wire non-forming area; and inspecting, based on the contrast image after the replacement processing, a defect of the wire as the inspection target.

### BRIEF DESCRIPTION OF THE DRAWINGS

FIG. 1 is a block diagram of a configuration of an inspection apparatus for a semiconductor substrate according to a first embodiment of the present invention;

FIG. 2 is a plan view of an example of a semiconductor substrate as an inspection target;

FIG. 3 is a diagram of an example of a waveform of a gray level acquired from a potential contrast image;

FIG. 4 is a diagram of a potential contrast image obtained by replacing images of trench wires with self-generated images;

FIG. 5 is a diagram of an example of a two-dimensional histogram used in a substrate inspection method according to the first embodiment;

FIG. 6 is a diagram of a difference in contrast in comparison of a non-defective image (a) and a defective image (b);

FIG. 7 is a diagram for explaining an image comparison system according to the first embodiment;

FIG. 8 is a flowchart of defect inspection according to the first embodiment;

FIG. 9 is a plan view of another example of the semiconductor substrate as the inspection target;

FIG. 10 is a diagram of an example of a waveform of a gray level acquired from a contrast image;

FIG. 11 is a diagram of a contrast image (an optical microscope image) obtained by replacing images of cell section end wires with self-generated images;

FIG. 12 is a flowchart of defect inspection according to a second embodiment of the present invention; and

FIG. 13 is a block diagram of a configuration of an inspection apparatus for a semiconductor substrate according to the second embodiment.

### DETAILED DESCRIPTION OF THE INVENTION

Exemplary embodiments of the present invention are explained in detail below with reference to the accompanying drawings. The present invention is not limited by the embodiments.

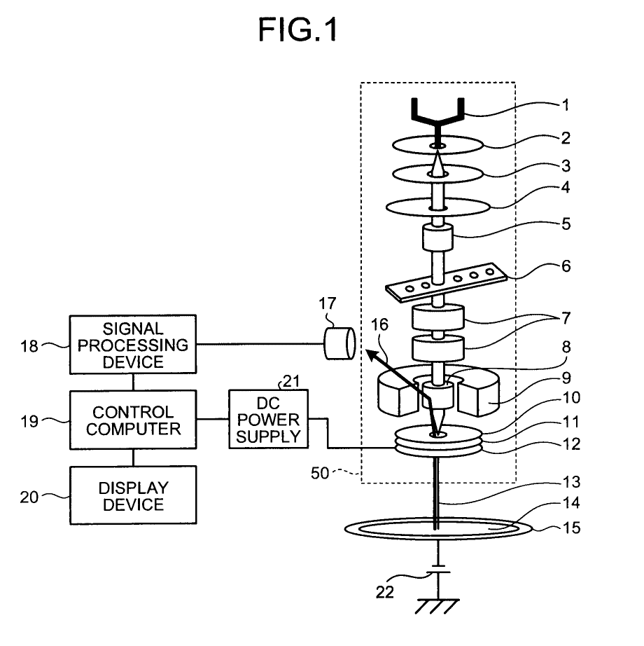

FIG. 1 is a block diagram of a configuration of an inspection apparatus for a semiconductor substrate according to a first embodiment of the present invention. As shown in FIG. 1, the inspection apparatus according to this embodiment includes a filament electrode 1, a suppressor electrode 2, an extractor electrode 3, a capacitor lens 4, a Wien filter (upper) 5, an aperture 6, a beam scanning deflector 7, a Wien filter (lower) 8, an object lens 9, a top electrode (ground (GND) potential) 10, an intermediate electrode 11, a focus control electrode 12, a substrate stage 15, a secondary electron detector 17, a signal processing device 18, a control computer 19, a display device 20, and a DC power supply 21. A semiconductor substrate 14 is mounted on the substrate stage 15. Negative voltage is applied to the substrate stage 15 by a DC power supply 22.

The filament electrode 1 is an electron source that generates an electron beam. The suppressor electrode 2, the extractor electrode 3, the capacitor lens 4, the Wien filter (upper) 5, the aperture 6, the beam scanning deflector 7, the Wien filter (lower) 8, the object lens 9, the top electrode (GND potential) 10, the intermediate electrode 11, and the focus control electrode 12 configure an electron optical system. The electron optical system controls the size, the track, the focus position, and the like of a beam bundle of a primary electron beam 13 irradiated on the semiconductor substrate 14. The primary electron beam 13 is focused to form an image on the surface of the semiconductor substrate 14 by the electron optical system. The focused primary electron beam 13 is scanned on the semiconductor substrate 14 by the beam scanning deflector 7. The filament electrode 1 and the electron optical system configure an irradiating unit 50.

The DC power supply 21 applies DC voltage to the focus control electrode 12 to control the focus of the primary electron beam 13. A secondary electron 16 as a secondary beam is emitted from the wire surface of the semiconductor substrate 14 by the irradiation of the primary electron beam 13. The secondary electron 16 is accelerated by an electric field formed between the semiconductor substrate 14 and the object lens 9 and made incident on the Wien filter 8. Then the secondary electron 16 is deflected by the Wien filter 8 and drawn into the second electro detector 17.

The secondary electron detector 17 detects the secondary electron 16 and outputs a signal corresponding to signal intensity (a detection amount) of the secondary electron 16. The signal processing device 18 converts the output of the secondary electron detector 17 into an image signal. The image signal is referred to as potential contrast image because the image signal has contrast corresponding to a potential distribution on an inspection surface of the semiconductor substrate 14. The image signal is represented by a gray level. Such a contrast is caused by differences of structures, materials, and the like of components in the semiconductor substrate 14.

The image signal generated by the signal processing device 18 is output to the control computer 19 as a control processing unit. As explained later, the control computer 19 replaces images of wires as noise sources of inspection in the image signal with self-generated images and determines, based on the image signal after this replacement processing, acceptability of wires as inspection targets. The display device 20 (e.g., a CRT) displays an inspection result together with images such as the potential contrast image.

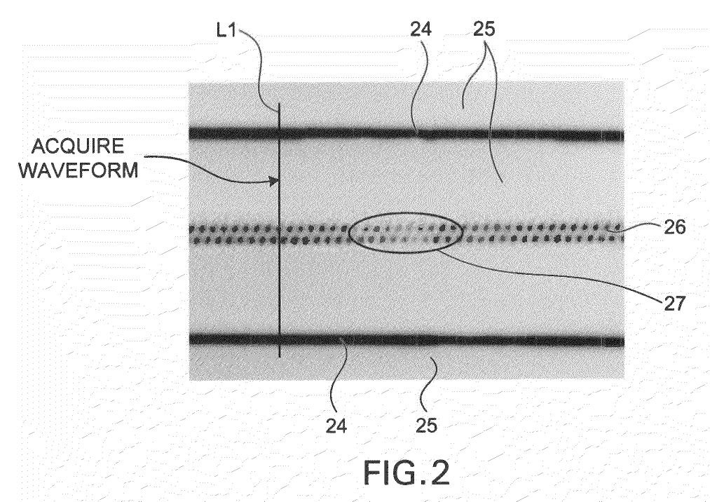

FIG. 2 is a plan view of an example of the semiconductor substrate 14 as an inspection target. As shown in FIG. 2, on the semiconductor substrate 14, the same layout patterns are repeatedly formed in order of a trench wire 24, an oxide film 25, a contact wire 26, and the oxide film 25 in a direction orthogonal to an extending direction of a trench wire 24 and a contact wire 26 (in FIG. 2, only a part of the layout patterns is shown). Specifically, a part of a memory cell area of a NAND memory and a part of wires thereof are shown. The contact wires 26 are contacts on a bit side and the trench wires 24 are contacts on a source side.

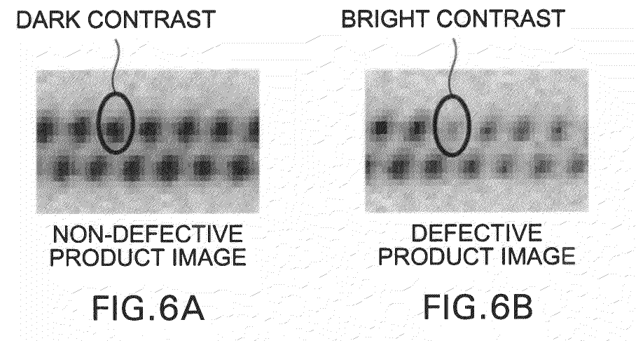

In FIG. 2, a defect candidate 27 of the contact wires 26 is shown. As it is seen from comparison with other sections of the contact wires 26, in the defect candidate 27, contrast is bright, whereas the contrast should originally be dark in a non-defective. FIG. 6 is an enlarged diagram of the contrast in the contact wires 26. Whereas bright contrast appears in a defective image (b), dark contrast appears in a corresponding section of a non-defective image (a). In the following explanation, the contact wires 26 are inspection targets (wires as inspection targets) and the trench wires 24 are wires that are not inspection targets (wires as non-inspection targets). The oxide films 25 form areas in which wires are not formed (wire non-forming areas).

The semiconductor substrate 14 is set on the substrate stage 15. When an electron beam (e.g., incident voltage=1000 eV, probe current=75 nA, and charge control voltage =−10 V) is irradiated on the surface of the semiconductor substrate 14, a potential contrast image as an image having contrast that depends on a potential distribution of the semiconductor substrate 14 is output from the signal processing device 18.

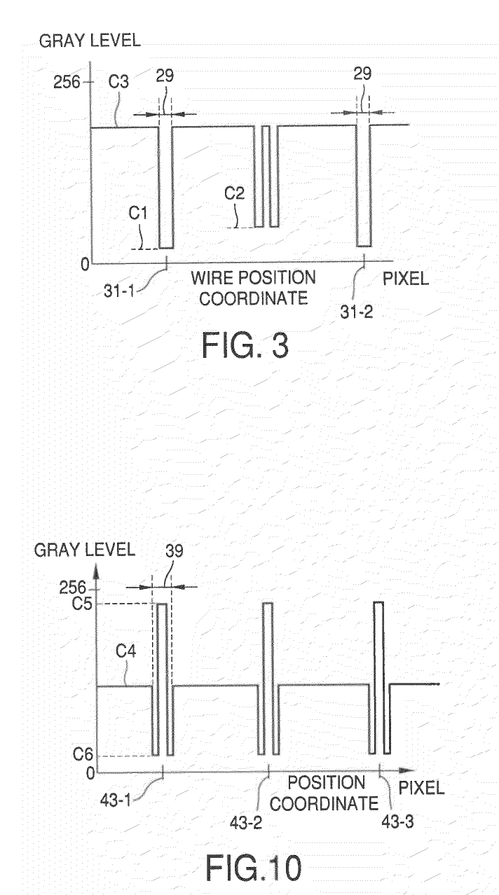

When the potential contrast image is acquired from the signal processing device 18, the control computer 19 acquires, for example, a waveform of a gray level along a straight line L1 shown in FIG. 2 from the potential contrast image. FIG. 3 is a diagram of an example of the waveform of the gray level acquired from the potential contrast image and, specifically, a waveform along the straight line L1. In FIG. 3, a position coordinate (indicated in pixel units) as a wire position coordinate along the straight line L1 is set as the abscissa and the gray level is set as the ordinate. The gray level is digitized and indicated in, for example, 256 gradations. A value of the gray level increases in order of a gray level C1 of the trench wires 24, a gray level C2 of the contact wires 26, and a gray level C3 of the oxide films 25. Brighter contrast is obtained in this order.

The control computer 19 calculates position coordinates 31-1 and 31-2 of the trench wires 24 and a dimension 29 of the trench wires 24 from the waveform shown in FIG. 3 and specifies image areas of the trench wires 24 in the potential contrast image. Further, the control computer 19 calculates the gray level C3 of the oxide films 25 from the waveform shown in FIG. 3. In calculating the gray level C3, the control computer 19 can calculate, for example, an average on the oxide films 25 or can obtain a value at specific one point. The dimension 29 of the trench wires 24 in FIG. 3 is specifically width. When information concerning the length of the trench wires 24 is necessary, the control computer 19 acquires the information from the potential contrast image.

Subsequently, the control computer 19 creates self-generated images for replacing images of the trench wires 24. The self-generated images are images with a gray level thereof set to the gray level C3 of the oxide films 25. In this embodiment, defect inspection is performed after the images of the trench wires 24 as noise sources in the potential contrast image are replaced with the self-generated images to eliminate noise.

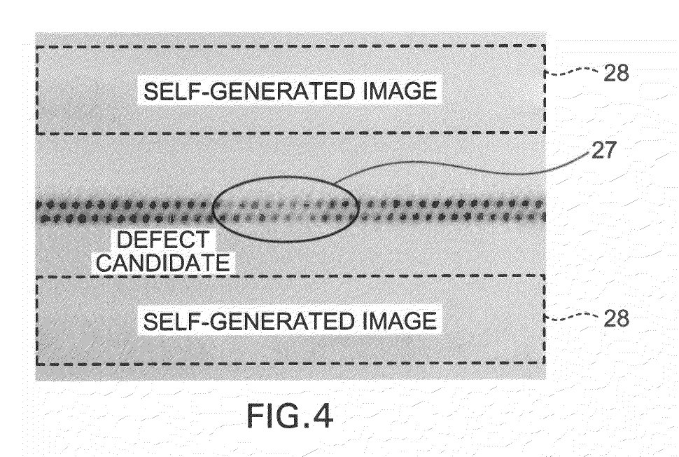

FIG. 4 is a diagram of a potential contrast image obtained by replacing the images of the trench wires 24 with self-generated images 28. In FIG. 4, the wires (the trench wires 24) as noise sources are replaced with the self-generated images 28. The self-generated images 28 are generated in size obtained by adding a slight margin to the image areas of the trench wires 24. However, the size can be arbitrarily set as long as the self-generated images 28 include the image areas of the trench wires 24 and do not overlap image areas of the contact wires 26.

As explained above, a difference occurs in a gray level (signal intensity) in a non-defective product and a defective product between corresponding sections in the contrast image.

Therefore, after the noise sources are eliminated as shown in FIG. 4, cell-to-cell image comparison or die-to-die image comparison is carried out, and presence or absence of a defect can be determined based on a value of the difference in the gray level.

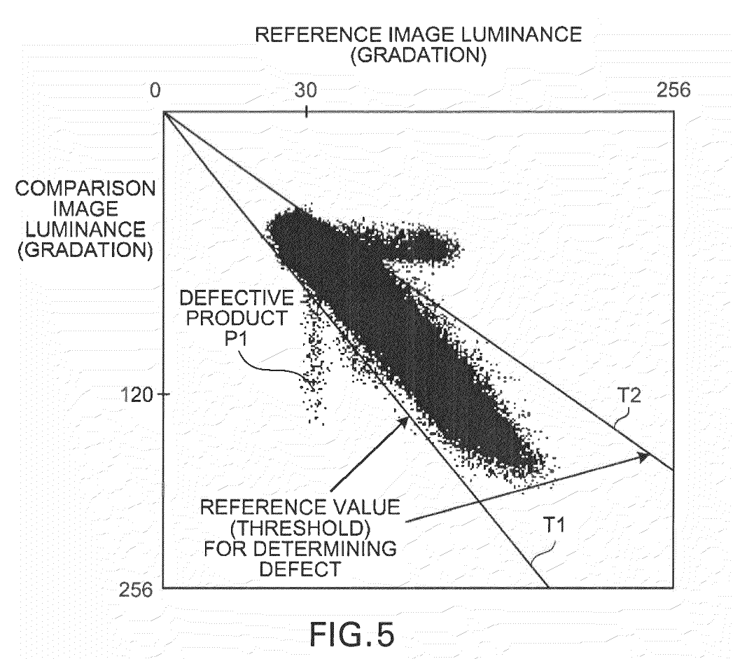

FIG. 5 is a diagram of an example of a two-dimensional histogram used in a substrate inspection method according to this embodiment. In FIG. 5, the abscissa represents the luminance (gradation) of a reference image and the ordinate represents the luminance (gradation) of a comparison image that is compared with the reference image. As an example, image comparison of a cell A (the reference image) and a cell B (the comparison image) is performed (the cell-to-cell image comparison system). First, the potential contrast image shown in FIG. 4 is created for each of the cells A and B. The two-dimensional histogram shown in FIG. 5 is created for the cells. Specifically, a gray level α of arbitrary one pixel in the cell A is taken as a value on the abscissa, a gray level β of a pixel in the cell B present in a position corresponding to the arbitrary pixel is taken as a value on the ordinate, and (α,β) is plotted. A set of points shown in FIG. 5. is obtained by plotting (α,β) for all pixels in the cells A and B.

When both the cells A and B are non-defective, α and β are substantially the same gradations. However, one of the cells A and B is defective, a deviation between α and β increases. Therefore, reference values (thresholds) for determination of a defect are set based on a distribution of the set of points shown in FIG. 5. Acceptability can be determined by comparing (α,β) with the thresholds. In the example shown in the figure, the thresholds are set by, for example, straight lines T1 and T2 passing through the origin of 0 gradation. Points located between the straight lines T1 and T2 are determined as non-defective (normal) and the other points are determined as defective (defects). For example, concerning a point P1, α=30 and β=120. This indicates that the cells A and B respectively correspond to dark contrast (gradation 30) in the non-defective image (a) shown in FIG. 6 and bright contrast (gradation 120) in the defective image (b) shown in FIG. 6 and a defect is present in the contact wires 26 in the cell B.

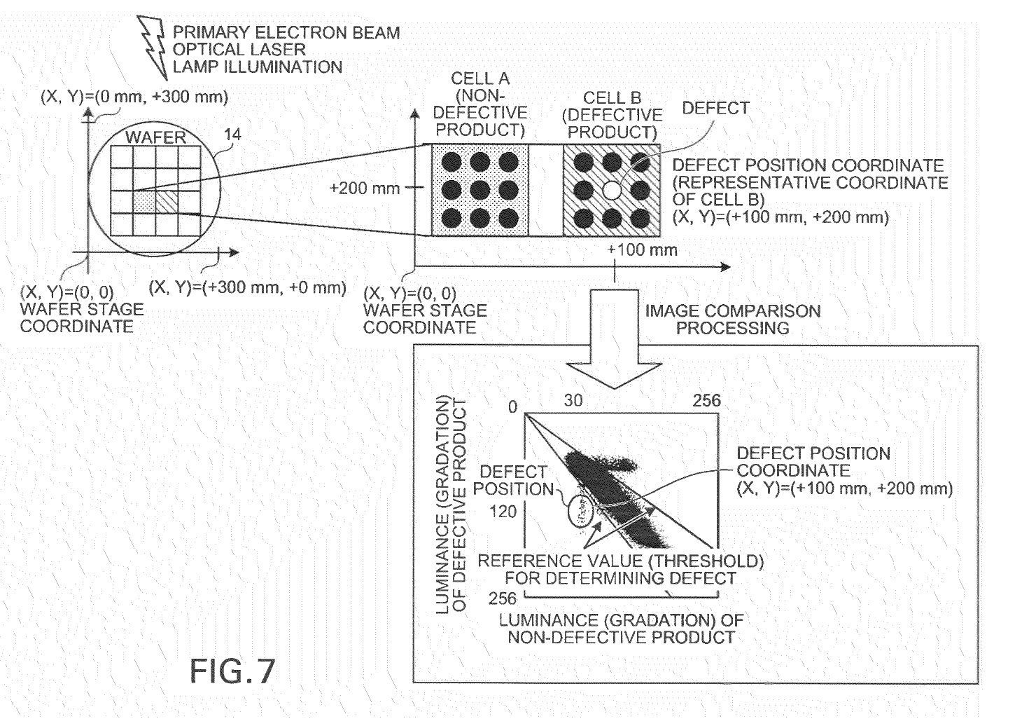

FIG. 7 is a diagram for explaining an image comparison system according to this embodiment. In FIG. 7, an example of image comparison concerning the adjacent cells A and B on the semiconductor substrate 14 is shown. The cell A is non-defective and the cell B is defective. A wafer stage coordinate in a defect section in the cell B is, for example, (X, Y)=(+100 mm, +200 mm). The wafer stage coordinate of the defect section or a coordinate described as a defect position coordinate in FIG. 7 is a coordinate indicating an arrangement position of a cell, for example, a position coordinate of the center of the cell. The wafer stage coordinate is an X-Y coordinate set on a wafer. In the example shown in the figure, X and Y are set in a range of 0 millimeter to 300 millimeters.

In this embodiment, the potential contrast image with noise sources eliminated shown in FIG. 4 is created for each of the cells A and B. Presence of a defect in the cell B can be determined by comparing the image of the cell A and the image of the cell B as shown in FIG. 5. The same holds true for the die-to-die image comparison system. Defect inspection is performed by comparing areas of the same pattern in different dies.

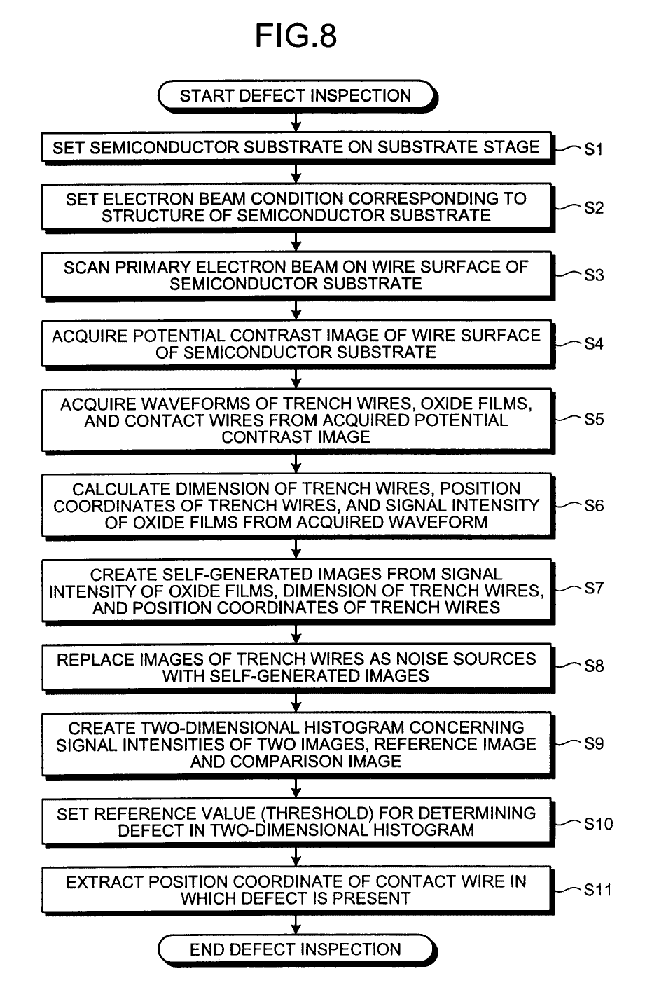

FIG. 8 is a flowchart of defect inspection according to this embodiment.

First, the semiconductor substrate 14 as an inspection target is set on the substrate stage 15 (S1). Subsequently, an electron beam condition corresponding to the structure of the semiconductor substrate 14 is set (S2). The semiconductor substrate 14 has, for example, wiring structure shown in FIG. 2. As the electron beam condition in this case is, as explained above, for example, incident voltage=1000 eV, probe current=75 nA, and charge control voltage=−10 V. Designation of an inspection target area is performed by selecting a place where wires are arranged periodically for a certain range in an arbitrary chip and causing the control computer 19 to store an area including the trench wires 24, the oxide films 25, and the contact wires 26 on the semiconductor substrate 14.

Subsequently, after a recipe including information necessary for defect inspection is selected in the control computer 19, wafer alignment is carried out. After the wafer alignment ends, inspection is started. First, the primary electron beam 13 is scanned on the semiconductor substrate 14 as the inspection target while moving the substrate stage 15 (S3) and a potential contrast image of the wire surface of the semiconductor substrate 14 is acquired (S4).

The control computer 19 acquires waveforms of the trench wires 24, the oxide films 25, and the contact wires 26 from the acquired potential contrast image (S5 in FIG. 3). The control computer 19 calculates the dimension 29 of the trench wires 24, the position coordinates 31-1 and 31-2 of the trench wires 24, and signal intensity (the gray level C3) of the oxide films 25 from the acquired waveforms (S6). The control computer 19 creates the self-generated images 28 shown in FIG. 4 from these kinds of information (S7). The control computer 19 replaces images of the trench wires 24 as noise sources with the self-generated images 28 (S8). In this way, the control computer 19 eliminates noise by replacing the images of the trench wires 24 as the noise sources with the self-generated images 28.

The control computer 19 creates a two-dimensional histogram concerning signal intensity of two images, for example, a reference image and a comparison image as cell images adjacent to each other (S9 in FIG. 5). In the two-dimensional histogram, the control computer 19 sets reference values (thresholds) for determining a defect (S10). This makes it possible to determine whether a defect of electric short-circuit or open-circuit is present in the contact wires 26. When it is determined that the defect is present, the control computer 19 extracts a position coordinate of the contact wire 26 in which the defect is present (S11). The position coordinate is given as a wafer stage coordinate of a cell as explained above.

According to this embodiment, even when wires as non-inspection targets (e.g., the trench wires 24) as noise sources are present in defect inspection, images of the wires as the non-inspection targets are replaced with the self-generated images 28 to eliminate the noise sources. Therefore, there is an effect that it is possible to highly accurately inspect whether a defect is present in wires as inspection targets (e.g., the contact wires 26).

Because the waveform of the gray level shown in FIG. 3 is acquired, the trench wires 24, the oxide films 25, the contact wires 26 can be specified from a change in the gray level. The positions and the dimension of the trench wires 24 and the gray level C3 of the oxide films 25 can be acquired. The self-generated images 28 can be easily created.

The two-dimensional histogram concerning luminance (gradations) of the reference image and the comparison image is created as shown in FIG. 5. Presence or absence of a defect is determined by setting the reference values (the thresholds) for determining a defect. Therefore, inspection of a defect can be easily and highly accurately carried out.

This embodiment can be suitably applied when wires as inspection targets and wires as non-inspection targets are regularly (periodically) arranged. In general, image comparison is performed cell to cell or die to die. However, the image comparison is not limited to this. The image comparison can be applied to images in a pair of areas on the semiconductor substrate 14 in which the same wiring patterns are respectively formed. As a beam irradiated on the semiconductor substrate 14, a beam of charged particles other than the electron beam can also be used.

The wires as the inspection targets, the wires as the non-inspection targets, and the wire non-forming areas in this embodiment are examples only. This embodiment can be applied to other examples as well.

In a second embodiment of the present invention, a light beam emitted from, for example, an optical laser or an optical lamp is used as an inspection beam. Specifically, the light beam is irradiated on a semiconductor substrate while being scanned. A contrast image is created according to signal intensity of reflected light reflected from the semiconductor substrate. After wire images as noise sources in the contrast image is replaced with self-generated images, a defect of wires as inspection targets is inspected by using the contrast image after the replacement processing.

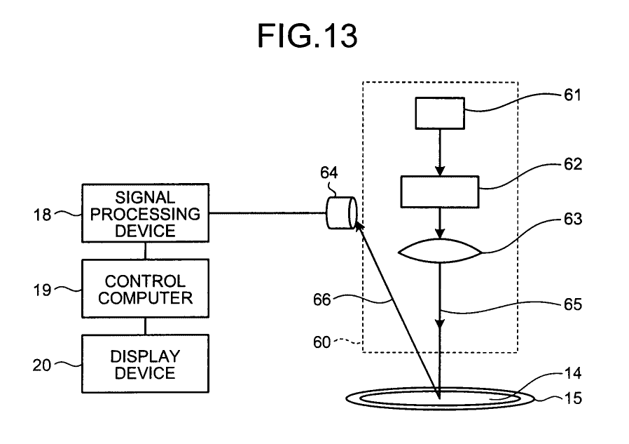

FIG. 13 is a block diagram of a configuration of an inspection apparatus for a semiconductor substrate according to this embodiment. As shown in FIG. 13, an irradiating unit 60 according to this embodiment includes a laser beam source 61 as a source of generation of a laser beam, a deflecting device 62 that deflects and scans a laser beam 65 emitted by the laser beam source 61, and an object lens 63 that converges the laser beam 65 on the semiconductor substrate 14. A photodetector 64 detects reflected light 66 as a secondary beam reflected from the semiconductor substrate 14 and outputs a signal corresponding to light intensity of the reflected light 66. In FIG. 13, only necessary minimum components of the irradiating unit 60 are shown and other components are not shown. In FIG. 13, components same as those shown in FIG. 1 are denoted by the same reference numerals and detailed explanation of the components is omitted.

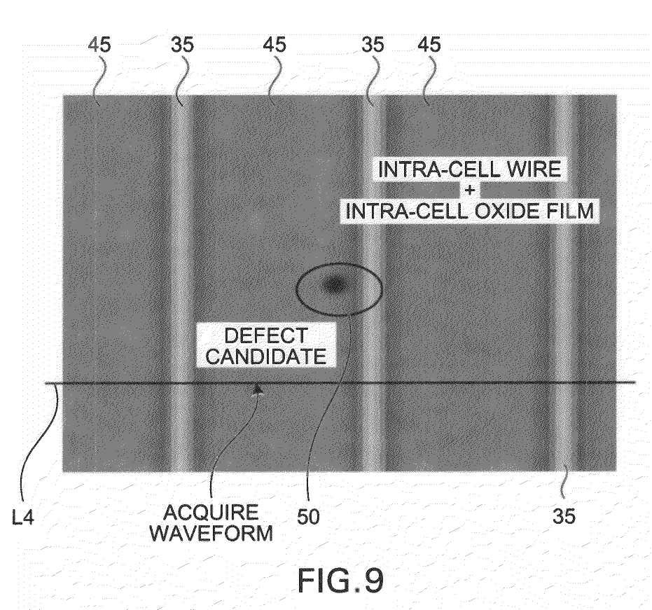

FIG. 9 is a plan view of another example of the semiconductor substrate 14 as the inspection target. As shown in FIG. 9, on the semiconductor substrate 14, cell sections 45 and cell section end wires 35 are alternately formed repeatedly. In the cell sections 45, intra-cell wires and intra-cell oxide films are respectively formed in predetermined sections. In FIG. 9, specifically, a part of a memory cell area of a NAND memory and a part of wires of the memory cell area are shown. The cell section end wires 35 indicate selected gate formation areas.

In FIG. 9, a defect candidate 50 of the intra-cell wires is shown. As it is seen from comparison with other sections in the cell sections 45, a defect section having dark contrast compared with the periphery is present in the defect candidate 50. In the following explanation, the intra-cell areas are inspection targets (wires as inspection targets), the cell section end wires 35 are wires that are not inspection targets (wires as non-inspection targets), and the intra-cell oxide films are areas in which wires are not formed (wire non-forming areas).

When the laser beam 65 is irradiated on the semiconductor substrate 14, a part of incident light is reflected by the semiconductor substrate 14. The photodetector 64 detects reflected light 66 having light intensity that depends on a state (e.g., the thickness and the material of wires) of an inspection surface of the semiconductor substrate. The signal processing device 18 outputs, based on a detection signal of the photodetector 64, a contrast image (an optical microscope image) as an image having contrast that depends on the intensity of the reflected light from the semiconductor substrate 14.

When the contrast image is acquired from the signal processing device 18, the control computer 19 acquires, for example, a waveform of a gray level along a straight line L4 shown in FIG. 9 from the contrast image. FIG. 10 is a diagram of an example of the waveform of the gray level acquired from the contrast image and, specifically, a diagram of a waveform along the straight line L4. In FIG. 10, a position coordinate (indicated in pixel units) as a wire position coordinate along the straight line L4 is set as the abscissa and the gray level is set as the ordinate. The gray level is digitized and indicated in, for example, 256 gradations.

A gray level of the intra-cell wires and the intra-cell oxide films in the cell sections 45 is C4. On the other hand, a gray level of the cell section end wires 35 is C5 (>C4). Areas having a gray level C6 lower than C4 are present on both the sides of the cell section end wires 35.

The control computer 19 calculates position coordinates 43-1, 43-2, and 43-3 of the cell section end wires 35 and a dimension 39 of the cell section end wires 35 from the waveform shown in FIG. 10 and specifies image areas of the cell section end wires 35 in the contrast image. Further, the control computer 19 calculates the gray level C4 from the waveform shown in FIG. 10. C4 is a gray level determined based on at least a gray level of the intra-cell oxide films and is, for example, an average of gray levels of the cell sections 45 (an average concerning the intra-cell oxide films and the intra-cell wires). The dimension 39 is specifically width. When information concerning the length of the cell section end wires 35 is necessary, the control computer 19 acquires the information from the contrast image. The dimension 39 includes areas up to low contrast areas (gradation C6) present on both the sides of the cell section end wires 35.

Subsequently, the control computer 19 creates self-generated images for replacing images of the cell section end wires 35. The self-generated images are images with a gray level thereof set to the gray level C4 of the cell sections 45. In this embodiment, defect inspection is performed after the images of the cell section end wires 35 as noise sources in the contrast image are replaced with the self-generated images to eliminate noise.

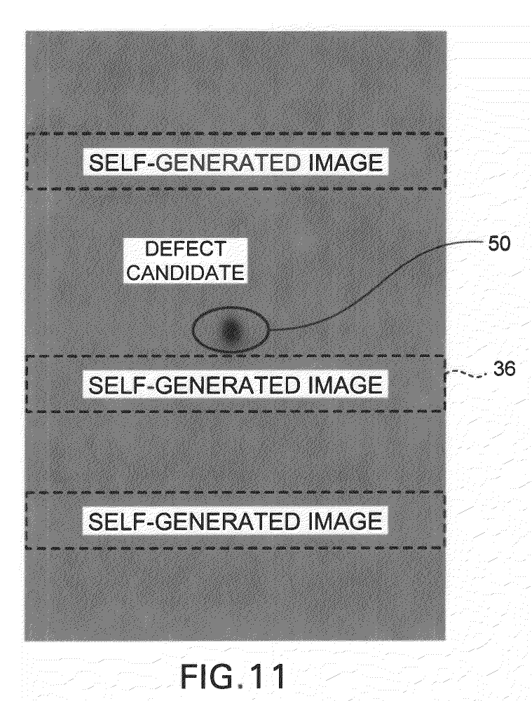

FIG. 11 is a diagram of a contrast image (an optical microscope image) obtained by replacing the images of the cell section end wires 35 with self-generated images 36. In FIG. 11, the wires (the cell section end wires 35) as noise sources are replaced with the self-generated images 36.

A difference occurs in a gray level (signal intensity) in a non-defective product and a defective product between corresponding sections in the contrast image. Therefore, after the noise sources are eliminated as shown in FIG. 11, cell-to-cell image comparison or die-to-die image comparison is carried out. Presence or absence of a defect can be determined based on a value of the difference in the gray level. An inspection method for inspecting a semiconductor substrate using a two-dimensional histogram is the same as that in the first embodiment (FIGS. 5 and 7). Therefore, explanation of the inspection method is omitted.

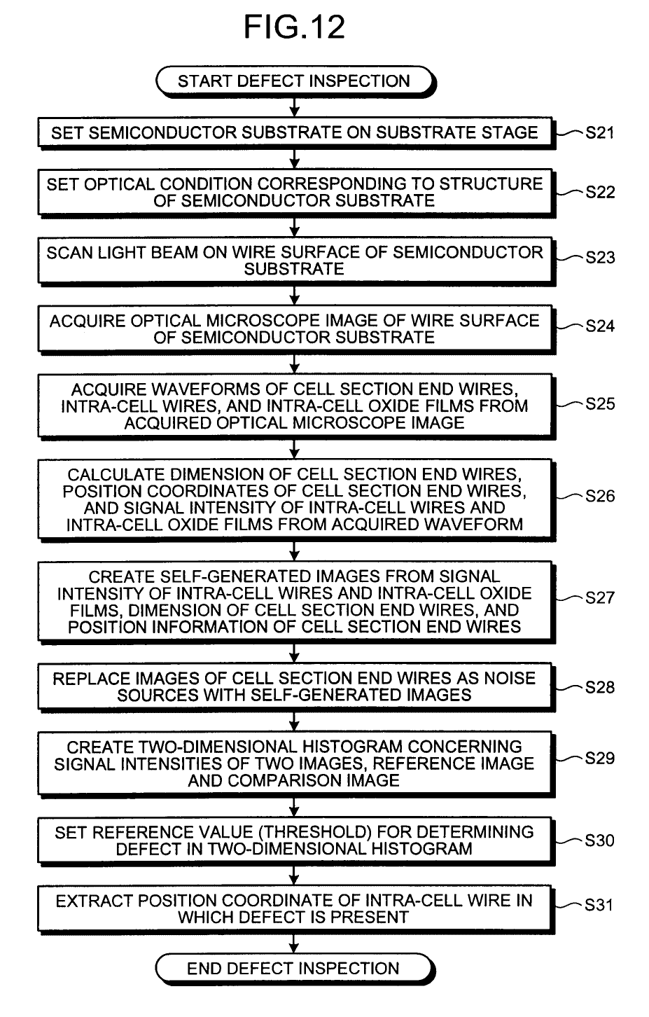

FIG. 12 is a flowchart of defect inspection according to this embodiment.

First, the semiconductor substrate 14 as an inspection target is set on the substrate stage 15 (S21). Subsequently, an optical condition corresponding to the structure of the semiconductor substrate 14 is set (S22). Designation of an inspection target area is performed by selecting a place where wires are arranged periodically for a certain range in an arbitrary chip and causing the control computer 19 to store an area including the cell sections 45 (the intra-cell wires and the intra-cell oxide films) and the cell section end wires 35 on the semiconductor substrate 14.

Subsequently, after a recipe including information necessary for defect inspection is selected in the control computer 19, wafer alignment is carried out. After the wafer alignment ends, inspection is started. First, a light beam (the laser beam 65) is scanned on the semiconductor substrate 14 as the inspection target while moving the substrate stage 15 (S23) and a contrast image (an optical microscope image) having contrast that depends on the thickness, the material, and the like of the wires on the semiconductor substrate 14 is acquired (S24).

The control computer 19 acquires waveforms of the cell section end wires 35, the intra-cell wires, and the intra-cell oxide films from the acquired contrast image (optical microscope image) (S25 in FIG. 10). The control computer 19 calculates the dimension 39 of the cell section end wires 35, the position coordinates 43-1, 43-2, and 43-3 of the cell section end wires 35, and signal intensity (the gray level C4) of the intra-cell wires and the intra-cell oxide films from the acquired waveforms (S26). The control computer 19 creates the self-generated images 36 shown in FIG. 11 from these kinds of information (S27). The control computer 19 replaces images of the cell section end wires 35 as noise sources with the self-generated images 36 (S28). In this way, the control computer 19 eliminates noise by replacing the images of the cell section end wires 35 as the noise sources with the self-generated image 36.

The control computer 19 creates a two-dimensional histogram concerning signal intensity of two images, for example, a reference image and a comparison image as cell images adjacent to each other (S29 in FIG. 5). In the two-dimensional histogram, the control computer 19 sets reference values (thresholds) for determining a defect (S30). This makes it possible to determine whether a defect of electric short-circuit or open-circuit is present in the intra-cell wires. When it is determined that the defect is present, the control computer 19 extracts a position coordinate of the intra-cell wire in which the defect is present (S31).

According to this embodiment, even when wires as non-inspection targets as noise sources (e.g., the cell section end wires 35) are present in defect inspection, images of the wires as the non-inspection targets are replaced with the self-generated images 36 to eliminate the noise sources. Therefore, there is an effect that it is possible to highly accurately inspect whether a defect is present in wires as inspection targets (e.g., the intra-cell wires). This embodiment can be suitably applied when wires as inspection targets and wires as non-inspection targets are regularly arranged. Other effects of this embodiment are the same as those of the first embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An inspection method for a semiconductor substrate comprising:
irradiating an inspection beam on wires formed on a semiconductor substrate while scanning the inspection beam;
detecting a secondary beam emitted from the semiconductor substrate according to the irradiation of the inspection beam;
generating a contrast image, which indicates a state of an inspection surface of the semiconductor substrate, according to a gray level corresponding to signal intensity of the secondary beam;
specifying, based on a change in the gray level in the contrast image, a wire as an inspection target and a wire as a non-inspection target and acquiring a position and a dimension of the wire as the non-inspection target and a gray level corresponding to a wire non-forming area;
replacing, based on the position and the dimension of the wire as the non-inspection target, an image of the wire as the non-inspection target in the contrast image with an image having the gray level corresponding to the wire non-forming area; and
inspecting, based on the contrast image after the replacement processing, a defect of the wire as the inspection target.

2. The inspection method for a semiconductor substrate according to claim 1, wherein
contrast images after the replacement processing are acquired for a pair of areas on the semiconductor substrate in which same wiring patterns are formed, respectively,
a two-dimensional histogram is created concerning a gray level of each of pixels in one contrast image after the replacement processing and a gray level of each of pixels in the other contrast image after the replacement processing, and
a threshold for determining a non-defective product and a defective product is applied to the histogram to inspect the defect of the wire as the inspection target.

3. The inspection method for a semiconductor substrate according to claim 2, wherein
the semiconductor substrate is mounted on a substrate stage, and when it is determined that a defect is present in the wire as the inspection target in one of the pair of areas, a position coordinate of the area indicated by a coordinate on the substrate stage is outputted as a defect position.

4. The inspection method for a semiconductor substrate according to claim 2, wherein both the pair of areas are cells or dies.

5. The inspection method for a semiconductor substrate according to claim 1, wherein
a waveform of a gray level along one direction including a gray level of the wire as the inspection target, the wire as the non-inspection target, and the wire non-forming area is acquired from the contrast image, and
the position and the dimension of the wire as the non-inspection target and the gray level corresponding to the wire non-forming area is acquired from the waveform.

6. The inspection method for a semiconductor substrate according to claim 5, wherein the gray level corresponding to the wire non-forming area is given as an average of gray levels of the wire non-forming area in the waveform.

7. The inspection method for a semiconductor substrate according to claim 5, wherein the gray level corresponding to the wire non-forming area is given as an average of gray levels of the wire as the inspection target and the wire non-forming area in the waveform.

8. The inspection method for a semiconductor substrate according to claim 1, wherein the wire as the inspection target and the wire as the non-inspection target are regularly arranged.

9. The inspection method for a semiconductor substrate according to claim 1, wherein the inspection beam is an electron beam.

10. The inspection method for a semiconductor substrate according to claim 9, wherein the contrast image is a potential contrast image having contrast corresponding to a potential distribution on the inspection surface of the semiconductor substrate.

11. The inspection method for a semiconductor substrate according to claim 1, wherein the inspection beam is a light beam.

12. The inspection method for a semiconductor substrate according to claim 1, wherein the wire as the inspection target is a contact wire, the wire as the non-inspection target is a trench wire, and the wire non-forming area is an oxide film.

13. The inspection method for a semiconductor substrate according to claim 1, wherein
a memory cell area is formed on the semiconductor substrate, and
the wire as the inspection target is an intra-cell wire, the wire as the non-inspection target is a cell section end wire, and the wire non-forming area is an intra-cell oxide film.

14. An inspection apparatus for a semiconductor substrate comprising:
an irradiating unit that irradiates an inspection beam on wires formed on a semiconductor substrate while scanning the inspection beam;
a secondary-beam detecting unit that detects a secondary beam emitted from the semiconductor substrate according to the irradiation of the inspection beam;
a signal processing unit that generates a contrast image, which indicates a state of an inspection surface of the semiconductor substrate, according to a gray level corresponding to signal intensity of the secondary beam; and
a control processing unit that specifies, based on a change in the gray level in the contrast image, a wire as an inspection target and a wire as a non-inspection target, acquires a position and a dimension of the wire as the non-inspection target and a gray level corresponding to a wire non-forming area, replaces, based on the position and the dimension of the wire as the non-inspection target, an image of the wire as the non-inspection target in the contrast image with an image having the gray level corresponding to the wire non-forming area, and inspects, based on the contrast image after the replacement processing, a defect of the wire as the inspection target.

15. The inspection apparatus for a semiconductor substrate according to claim 14, wherein the control processing unit acquires contrast images after the replacement processing for a pair of areas on the semiconductor substrate in which same wiring patterns are formed, respectively, creates a two-dimensional histogram concerning a gray level of each of pixels in one contrast image after the replacement processing and a grey level of each of pixels in the other contrast image after the replacement processing, and applies a threshold for determining a non-defective and a defective to the histogram to inspect the defect of the wire as the inspection target.

16. The inspection apparatus for a semiconductor substrate according to claim 15, wherein
the semiconductor substrate is mounted on a substrate stage, and
the control processing unit outputs, when it is determined that a defect is present in the wire as the inspection target in one of the pair of areas, a position coordinate of the area indicated by a coordinate on the substrate stage as a defect position.

17. The inspection apparatus for a semiconductor substrate according to claim 14, wherein the control processing unit acquires, from the contrast image, a waveform of a gray level along one direction including a gray level of the wire as the inspection target, the wire as the non-inspection target, and the wire non-forming area and acquires, from the waveform, the position and the dimension of the wire as the non-inspection target and the gray level corresponding to the wire non-forming area.

18. The inspection apparatus for a semiconductor substrate according to claim 17, wherein the gray level corresponding to the wire non-forming area is given as an average of gray levels of the wire non-forming area in the waveform.

19. The inspection apparatus for a semiconductor substrate according to claim 17, wherein the gray level corresponding to the wire non-forming area is given as an average of gray levels of the wire as the inspection target and the wire non-forming area in the waveform.

20. The inspection apparatus for a semiconductor substrate according to claim 14, wherein the inspection beam is an electron beam or a light beam.
